(19) United States
(12) Patent Application Publication
(10) Pub. No.: US 2009/0083950 A1
(43) Pub. Date: Apr. 2, 2009

(54) CLAMP

(76) Inventor: Thomas Corogin, Port Clinton, OH (US)

Correspondence Address: FRASER CLEMENS MARTIN & MILLER LLC, 28366 KENSINGTON LANE, PERRYSBURG, OH, 43551, US

(21) Appl. No.: 11/865,144

(22) Filed: Oct. 1, 2007

(51) Int. Cl. F16L 33/08

(52) U.S. Cl. 24/274 R

(57) ABSTRACT

A clamp is disclosed including a flexible elongate band having spaced apart ends, one end having a plurality of slots formed therein and the opposite end having a screw assembly disposed thereon, wherein the screw assembly includes a rotatable screw mounted in a housing. Rotation of the screw urges an outer surface of one end of the band to slideably travel along an inclined inner surface and thence along the inner surface of the other end of the band for constricting and expanding the clamp.

### FIELD OF THE INVENTION

The invention relates to a clamp and more particularly to a hose and pipe clamp including a flexible band, wherein one end of the band travels along an inner surface of the other end to militate against clamp loosening, undesirable frictional engagement with adjacent surfaces, or injury to the skin of operating personnel.

### BACKGROUND OF THE INVENTION

Hose and pipe clamps are well known in the art. Typically, such clamps include a flexible band having two ends, a plurality of notches formed along one end thereof, a housing affixed to the opposite end, and a screw disposed in the housing adapted to cooperate with the notches of the band. Generally, one end of the band overlaps the opposite end of the band to produce a circular arrangement that contacts the outer diameter of the hose or pipe, for example.

The clamp is tightened by the operation of the screw. The screw cooperates with the notches of the band causing one end of the band to slideably travel along an outer surface of the band. The diameter of the band is caused to decrease until the force applied to the hose by the band secures the hose to a desired object.

One such clamp is described in U.S. Pat. No. 5,809,619 to Schaub entitled HOSE CLAMP. The patent discloses a clamp including a housing having a ramp extending from the housing wall, a rotatable screw mounted within the housing, and a clamp band having spaced apart slots formed along the length of the band. The band is inserted into the housing, causing the ramp to urge the screw upwardly, to facilitate the ease of insertion. The screw cooperates with the slots in the band to adjust the diameter of the clamp.

A problem with such clamps is that the free end portion of the band projecting from the housing is caused to extend over the outer surface of the band rendering the clamp susceptible to loosening, undesirable frictional engagement with adjacent surfaces, injury of the skin of operating personnel, or impractical for certain applications.

Presently there are hose clamps including features which militate against a loosening of the clamp by securing the free end of the band to the outer surface of the other end. One such clamp is U.S. Pat. No. 6,205,624 to Mockridge entitled HOSE CLIP AND A LOCKING MEMBER THEREFOR. The patent discloses a clamp having a strap and a locking member disposed on the free end of the strap. The locking member is provided to militate against the opening-up of the clamp.

It would be desirable to produce a clamp which includes a flexible band having two ends, the one end having a plurality of slots, and the opposite end having a screw assembly disposed thereon, which cooperates with the slots to urge the one end of the band along the inner surface of the band, and which is economical to manufacture and may be installed without any special tools.

### SUMMARY OF THE INVENTION

A clamp including a flexible band, wherein one end of the band travels along an inner surface of the other end to militate against clamp loosening, undesirable frictional engagement with adjacent surfaces, or injury to the skin of operating personnel has been surprisingly discovered.

In an embodiment of the invention, the clamp comprises an elongate band having spaced apart ends and an inner and outer surface; and a means coupled to one end of the band for effecting relative movement between the spaced apart ends of the band for selectively constricting and expanding the band, whereby the outer surface of the other end of the band is caused to travel along the inner surface of the one end.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a clamp incorporating the features of the present invention wherein the clamp is illustrated in a fully open position;

FIG. 2 is an elevational view in section of the clamp illustrated in FIG. 1, wherein the clamp is in a closed operative position;

FIG. 3 is a perspective view of a clamp including a band similar to the band illustrated in FIGS. 1 and 2, wherein the clamp is illustrated in a fully open position; and

FIG. 4 is a cross-sectional view of the band illustrated in FIG. 3.

### DETAILED DESCRIPTION OF THE PREFERRED EMBODIMENT

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

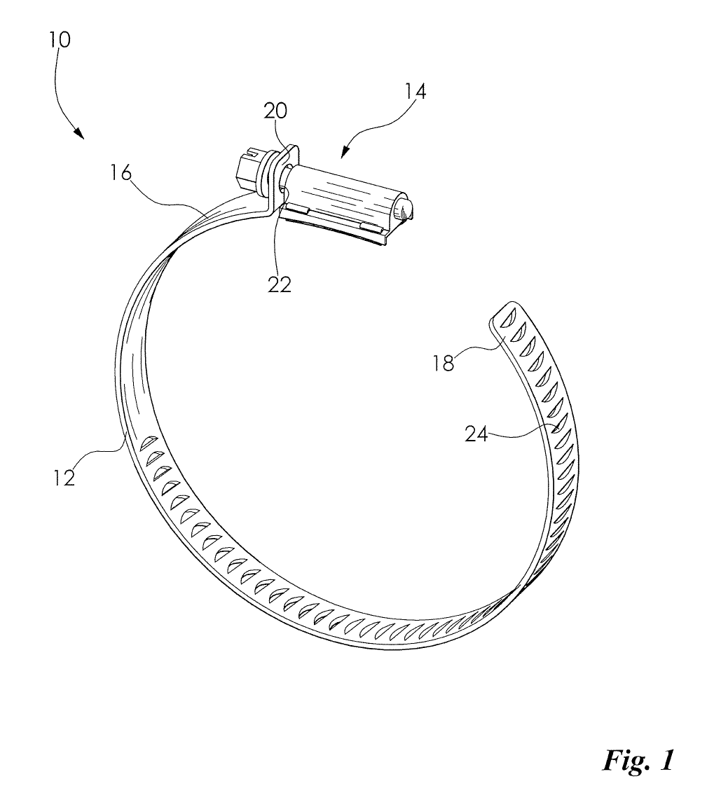

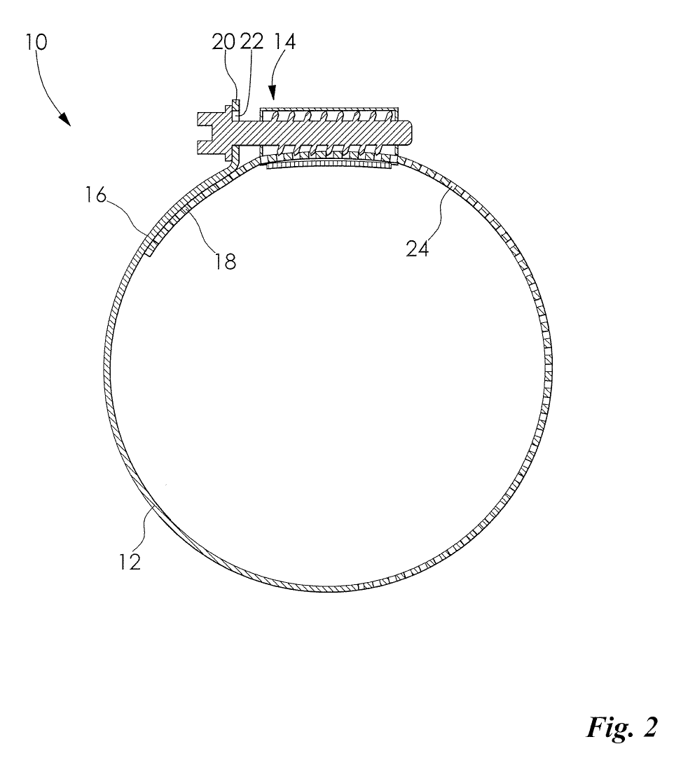

Referring to the drawings, FIGS. 1 and 2 show a clamp generally indicated by reference numeral 10 including a flexible elongate strap or band 12 having spaced apart ends and a means coupled to one end for effecting relative movement between the ends of the band 12 to constrict or expand the dimension of the clamp 10.

The band 12 includes an end 16, an opposite end 18, an inner surface, and an outer surface. In the operative clamping relation, the end 16 is caused to overlap the end 18 to form a generally circular loop, as shown in FIG. 2. The end 18 includes a plurality of slots 24 formed generally perpendicular to the longitudinal axis of the band 12. The end 16 terminates in a flange 20 extending upwardly therefrom. It will be noted the juncture of the end 16 and the flange 20 is formed to provide a smoothly inclined inner surface. An aperture 22 is formed in the flange 20. It will be understood that the slots 24 may extend to the end 16 of the band 12, if desired. The slots 24 may be other configurations such as upstanding ribs or teeth, for example.

The band 12 may include a surface to reduce the coefficient of friction to facilitate relative movement of adjacent surfaces during use. A lubricating coating may be applied on the inner surface.

The means for effecting relative movement between the ends 16, 18 of the band 12 includes an actuator on the end 16 to contact the outer surface of the end 18 of the band 12. As clearly illustrated in FIG. 2, the means for effecting relative movement between the ends 16, 18 of the band 12 is a screw assembly 14. One such screw assembly 14 is described in U.S. Pat. No. 5,560,087 to Marques entitle LATERALLY SECURE HOSE-CLAMP ASSEMBLY, incorporated herein by reference in its entirety.

The assembly 14 includes a threaded screw rotatably mounted in a housing. An outer diameter of the threads of the screw are larger than the diameter of the aperture 22. Prior to mounting the screw within the housing, the screw assembly 14 is secured to the band 12 by operating the screw to cause the threads to contact and travel though the aperture 22 of the flange 20.

In operation, the end 18 of the band 12 is inserted into the screw assembly 14 between the threaded screw and a base of the housing. The screw is then rotated in a direction causing the threads to cooperate with the slots 24 of the band 12, thereby urging the outer surface of the end 18 of the band 12 to slideably travel along the inclined inner surface of the juncture of the flange 20 of the end 16 and thence along the inner surface of the end 16 of the band 12, as shown in FIG. 2. Conversely, the screw can be rotated in the opposite direction causing the threads to cooperate the slots 24 of the band 12, thereby urging the outer surface of the end 18 to slideably retract along the inner surface of the end 16 of the band 12 and expand the clamp 10. The inclined inner surface of the end 16 of the band 12 guides the movement of the end 18 of the band 12.

Optionally, the means for effecting relative movement between the ends 16, 18 of the band 12 may include a surface to increase the coefficient of friction to militate against relative movement of adjacent surfaces during use. Any conventional means as are known in the art may be employed, such as mechanically or chemically treating, coating, or any combination thereof. A plurality of protuberances may be formed thereon such as ribs, teeth, and the like.

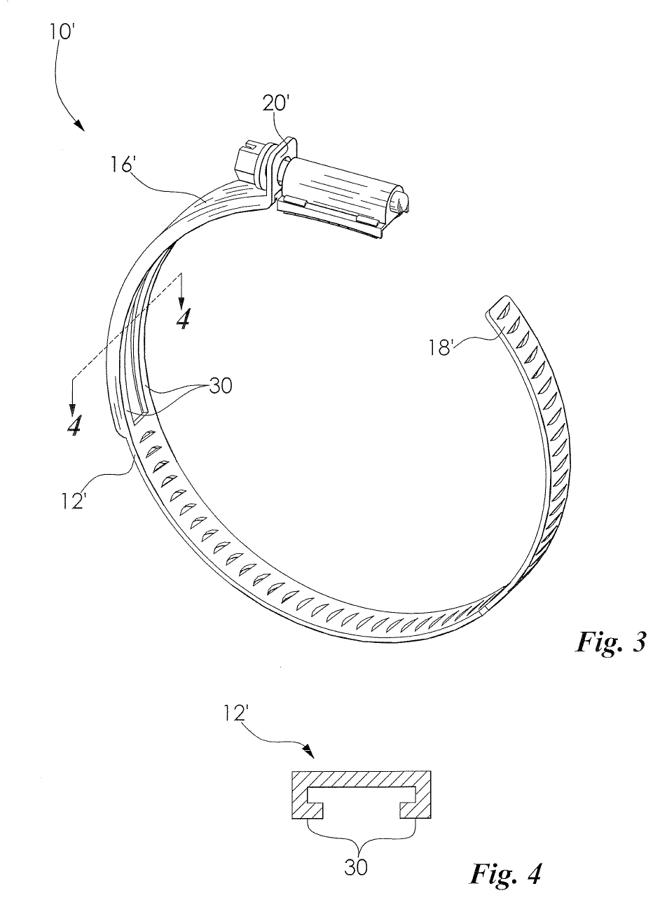

FIGS. 3 and 4 show another embodiment of the invention which includes a flexible elongate band similar to that shown in FIGS. 1 and 2. Reference numerals for similar structure in respect of the description of FIGS. 1 and 2 are repeated in FIGS. 3 and 4 with a prime (′) symbol. In certain applications it would be desirable to produce a clamp which militates against an undesirable frictional engagement with adjacent surfaces of the object being clamped.

The above objective can be achieved by a clamp 10′ including a pair of spaced apart flanges 30 formed on an inner surface of an end 16′ of a band 12′. The flanges 30 are formed to extend laterally inward and in a direction substantially parallel to the longitudinal axis of the band 12′. It is noted that the flanges 30 are formed on the inner surface of the band 12′ to extend from the juncture of the flange 20′ to an intermediate portion of the band 12′. The flanges 30 guide the movement of the end 18′ of the band 12′.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A clamp comprising:
an elongate band having a first end, a second end, an inner surface, and an outer surface; and
a means coupled to the first end of the band for effecting relative movement between the first end and the second end of the band for selectively constricting and expanding the band, whereby the outer surface of the second end of the band is caused to travel along the inner surface of the first end of the band.

2. The clamp according to claim 1, wherein the means coupled to the first end of the band for effecting relative movement between the first end and the second end of the band includes an actuating means for contacting the outer surface of the second end of the band.

3. The clamp according to claim 2, wherein the first end of the band includes an upturned flange for receiving the actuating means.

4. The clamp according to claim 2, wherein the actuating means includes a rotatable screw having radially outwardly extending threads.

5. The clamp according to claim 2, wherein the outer surface of the second end of the band includes at least one detent for contact with the actuating means.

6. The clamp according to claim 5, wherein the detent is a slot.

7. The clamp according to claim 1, wherein the first end of the band includes an inclined inner surface to guide the movement of the second end of the band.

8. The clamp according to claim 1, wherein a coating is applied to the band to reduce a coefficient of friction thereof.

9. The clamp according to claim 1, wherein the means coupled to the first end of the band for effecting relative movement between the first end and the second end of the band for selectively constricting and expanding the band includes a surface provided with at least one of a mechanical treatment, a chemical treatment, a coating, and a plurality of protuberances to increase a coefficient of friction thereof.

10. A clamp comprising:
an elongate band including a first end, a second end, an inner surface, and an outer surface, wherein the first end of the band includes an upturned flange and a plurality of flanges extending laterally inward and the second end includes an outer surface having at least one detent; and
a means coupled to the first end of the band for effecting relative movement between the first end and the second end of the band including an actuating means disposed in the upturned flange for contacting the outer surface of the second end of the band for selectively constricting and expanding the band, whereby the second end of the band is caused to travel between the inner surface of the first end of the band and the flanges extending laterally inward.

11. The clamp according to claim 10, wherein the actuating means is a rotatable screw having radially outwardly extending threads.

12. The clamp according to claim 10, wherein the detent is a slot.

13. The clamp according to claim 10, wherein the first end of the band includes an inclined inner surface to guide the movement of the second end of the band.

14. The clamp according to claim 10, wherein a coating is applied to the band to reduce a coefficient of friction thereof.

15. The clamp according to claim 10, wherein the means coupled to the first end of the band for effecting relative movement between the first end and the second end of the band for selectively constricting and expanding the band includes a surface provided with at least one of a mechanical treatment, a chemical treatment, a coating, and a plurality of protuberances to increase a coefficient of friction thereof.

16. A clamping system comprising:
an elongate band having a first end, a second end, an inner surface, and an outer surface, wherein the first end of the band includes an upturned flange and an inclined inner surface to guide the movement of the second end of the band, and the outer surface of the second end of the band includes at least one detent;
a screw assembly including a screw disposed in a housing for selectively constricting and expanding the band when the band is generally circular, wherein the screw assembly is adapted to be disposed in an aperture formed in the flange, the housing includes a cover and a base adapted to receive the second end of the band, and the screw includes radially outwardly extending threads, whereby the threads cooperate with at least one detent of the band to urge the outer surface of the second end of the band to travel along the inclined inner surface of the juncture of the flange and thence along the inner surface of the first end of the band; and
a body having a substantially circular cross-sectional shape, wherein a rotation of the screw in a direction causes the threads of the screw to cooperate with at least one detent of the band to constrict the clamp onto the body, and a rotation of the screw in an opposite direction causes the threads of the screw to cooperate with at least one detent of the band to loosen the clamp from the body.

17. The clamping system according to claim 16, wherein the detent is a slot.

18. The clamp according to claim 16, wherein a coating is applied to the band to reduce a coefficient of friction thereof.

19. The clamp according to claim 16, wherein the base of the housing of the screw assembly includes a surface provided with at least one of a mechanical treatment, a chemical treatment, a coating, and a plurality of protuberances to increase a coefficient of friction thereof.

20. The clamping system according to claim 16, wherein the body is pipe and hose work pieces.
